(19) United States
(12) Patent Application Publication
(10) Pub. No.: US 2012/0175550 A1
(43) Pub. Date: Jul. 12, 2012

(54) AQUEOUS DISPERSION FOR CHEMICAL MECHANICAL POLISHING AND CHEMICAL MECHANICAL POLISHING METHOD USING SAME

(75) Inventors: Atsushi Baba, Yokkaichi City (JP); Tatsuyoshi Kawamoto, Suzuka City (JP); Yugo Tai, Yokkaichi City (JP); Yasutaka Kamei, Yokkaichi City (JP)

(73) Assignee: JSR CORPORATION, Tokyo (JP)

(21) Appl. No.: 13/389,325

(22) PCT Filed: Jul. 15, 2010
(86) PCT No.: PCT/JP2010/061939

§ 371 Date: Mar. 23, 2012

(30) Foreign Application Priority Data
Aug. 7, 2009 (JP) 2009-184618

(51) Int. Cl. C09K 13/00; B82Y 30/00

(52) U.S. Cl. 252/79.1; 977/773

(57) ABSTRACT

A chemical mechanical polishing aqueous dispersion includes (A) silica particles, and (B) a compound that includes two or more carboxyl groups, a particle size (Db) of the silica particles (A) that is detected with a highest detection frequency (Fb) being larger than 35 nm and 90 nm or less, and a ratio (Fa/Fb) of a detection frequency (Fa) that corresponds to a particle size (Da) of larger than 90 nm and 100 nm or less to the detection frequency (Fb) being 0.5 or less when measuring a particle size distribution of the chemical mechanical polishing aqueous dispersion by a dynamic light scattering method.

### TECHNICAL FIELD

The present invention relates to a chemical mechanical polishing aqueous dispersion, and a chemical mechanical polishing method using the chemical mechanical polishing aqueous dispersion.

### BACKGROUND ART

A damascene interconnect used for large scale integration (LSI) may be formed using chemical mechanical polishing (hereinafter may be referred to as “CMP”). CMP that produces a damascene interconnect may include a step of mainly removing an interconnect metal (e.g., copper) by CMP (first polishing step), and a step of removing the interconnect metal, a barrier metal film (e.g., tantalum or titanium), and an insulating film by CMP to implement planarization (second polishing step) (refer to JP-A-2001-77062, for example).

In the second polishing step, it is necessary to obtain a flat polished surface by suppressing dishing that may occur in the interconnect area while maintaining the polishing rate by controlling the polishing rate of each material (e.g., interconnect metal, barrier metal (e.g., tantalum or titanium), and insulating material) that is exposed on the polishing target surface. It is also necessary to suppress occurrence of surface defects (scratches) and corrosion of the interconnect.

Since the interconnect width has been increasingly reduced, development of a chemical mechanical polishing aqueous dispersion that can polish the interconnect metal, the barrier metal film, and the insulating film (interlayer dielectric) at a higher polishing rate, can implement a higher degree of planarization, and can further suppress polishing defects (e.g., scratches and corrosion) has been desired.

### SUMMARY OF THE INVENTION

### Technical Problem

An object of the invention is to provide a chemical mechanical polishing aqueous dispersion that can polish the interconnect metal, the barrier metal film, and the insulating film at a high polishing rate while implementing a high degree of planarization, can suppress scratches that may occur on the interconnect and the insulating film, and can suppress corrosion of the interconnect, and a chemical mechanical polishing method using the chemical mechanical polishing aqueous dispersion.

### Solution to Problem

According to one aspect of the invention, there is provided a chemical mechanical polishing aqueous dispersion including (A) silica particles, and (B) a compound that includes two or more carboxyl groups, a particle size (Db) of the silica particles (A) that is detected with a highest detection frequency (Fb) being larger than 35 nm and 90 nm or less, and a ratio (Fa/Fb) of a detection frequency (Fa) that corresponds to a particle size (Da) of larger than 90 nm and 100 nm or less to the detection frequency (Fb) being 0.5 or less when measuring a particle size distribution of the chemical mechanical polishing aqueous dispersion by a dynamic light scattering method.

In the chemical mechanical polishing aqueous dispersion, the silica particles (A) may have a D50 volume percent particle size of 10 to 300 nm.

In the chemical mechanical polishing aqueous dispersion, the compound (B) may be at least one compound selected from maleic acid, malic acid, malonic acid, tartaric acid, glutaric acid, citric acid, and phthalic acid.

The chemical mechanical polishing aqueous dispersion may further include (C) at least one compound selected from a compound shown by a general formula (1), a compound shown by a general formula (2), and a compound shown by a general formula (3),

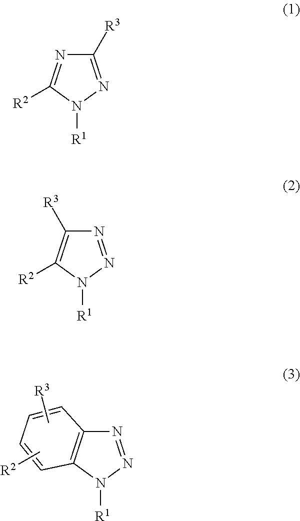

wherein R¹, R², and R³ independently represent a hydrogen atom, an alkyl group, an aryl group, an alkoxy group, an amino group, an aminoalkyl group, a hydroxyl group, a hydroxyalkyl group, a carboxyl group, a carboxyalkyl group, a mercapto group, or a carbamoyl group, provided that R² and R³ may bond to each other to form a ring.

The chemical mechanical polishing aqueous dispersion may further include (D) at least one compound selected from a compound shown by a general formula (4) and a compound shown by a general formula (5),

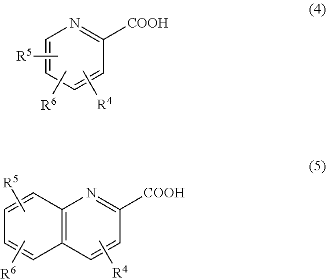

wherein R⁴, R⁵, and R⁶ independently represent a hydrogen atom, a substituted or unsubstituted alkyl group, or a carboxyl group, provided that R⁵ and R⁶ may bond to each other to form a ring.

In the chemical mechanical polishing aqueous dispersion, the compound (D) may be at least one compound selected from quinolinic acid and quinaldic acid.

The chemical mechanical polishing aqueous dispersion may have a pH of 7.0 to 11.0.

According to another aspect of the invention, there is provided a chemical mechanical polishing method using the chemical mechanical polishing aqueous dispersion.

### EFFECTS OF THE INVENTION

The chemical mechanical polishing aqueous dispersion can polish the interconnect metal, the barrier metal film, and the insulating film at a high polishing rate while implementing a high degree of planarization, can suppress scratches that may occur on the interconnect and the insulating film, and can suppress corrosion of the interconnect.

### BRIEF DESCRIPTION OF DRAWINGS

FIG. 1 is a graph of the particle size distribution of a chemical mechanical polishing aqueous dispersion used in Example 1.

### DESCRIPTION OF EMBODIMENTS

Preferred embodiments of the invention are described in detail below. Note that the invention is not limited to the following embodiments. Various modifications may be made of the following embodiments without departing from the scope of the invention.

### 1. Chemical Mechanical Polishing Aqueous Dispersion

A chemical mechanical polishing aqueous dispersion according to one embodiment of the invention includes (A) silica particles, and (B) a compound that includes two or more carboxyl groups, a particle size (Db) of the silica particles (A) that is detected with a highest detection frequency (Fb) being larger than 35 nm and 90 nm or less, and a ratio (Fa/Fb) of a detection frequency (Fa) that corresponds to a particle size (Da) of larger than 90 nm and 100 nm or less to the detection frequency (Fb) being 0.5 or less when measuring a particle size distribution of the chemical mechanical polishing aqueous dispersion by a dynamic light scattering method. The chemical mechanical polishing aqueous dispersion according to one embodiment of the invention is described in detail below. Note that the silica particles (A) and the like may be referred to as “component (A)” and the like.

### 1.1. Component (A)

The chemical mechanical polishing aqueous dispersion according to one embodiment of the invention includes the silica particles (A). Examples of the silica particles (A) include fumed silica that is synthesized by a fuming method that reacts silicon chloride or the like with oxygen and hydrogen in a gas phase, silica synthesized by a sol-gel method that subjects a metal alkoxide to hydrolysis and condensation, colloidal silica which is synthesized by an inorganic colloid method or the like and from which impurities have been removed by purification; and the like. Among these, it is preferable to use colloidal silica which is synthesized by an inorganic colloid method or the like and from which impurities have been removed by purification.

It is preferable that the silica particles (A) have a spherical shape. Note that the term “spherical shape” used herein includes an approximately spherical shape that does not include an acute-angle part. Specifically, the silica particles (A) need not necessarily have a shape close to a true sphere. The polishing target can be polished at a sufficient polishing rate by utilizing spherical silica particles. Moreover, occurrence of scratches and the like on the polishing target surface may be effectively suppressed.

The D50 volume percent particle size of the component (A) measured by a dynamic light scattering method is preferably 10 to 300 nm, more preferably 20 to 100 nm, and particularly preferably 30 to 80 nm. If the component (silica particles) (A) have a D50 volume percent particle size within the above range, a stable chemical mechanical polishing aqueous dispersion that achieves a sufficiently high polishing rate, and prevents precipitation or separation of the silica particles can be obtained.

The content of the component (A) in the chemical mechanical polishing aqueous dispersion is preferably 1 to 30 mass %, more preferably 2 to 20 mass %, and particularly preferably 3 to 10 mass %, based on the total mass of the chemical mechanical polishing aqueous dispersion. If the content of the component (A) is within the above range, a sufficiently high polishing rate can be achieved. This prevents a situation in which it takes time to complete the polishing step.

### 1.2. Detection Frequency Ratio (Fa/Fb)

The particle size (Db) of the silica particles (A) that is detected with the highest detection frequency (Fb) is larger than 35 nm and 90 nm or less when measuring the particle size distribution of the chemical mechanical polishing aqueous dispersion according to one embodiment of the invention by a dynamic light scattering method. The particle size (Db) of the silica particles (A) that is detected with the highest detection frequency (Fb) is preferably larger than 35 nm and 87.3 nm or less, more preferably larger than 35 nm and 76.2 nm or less, and particularly preferably larger than 35 nm and 66.6 nm or less. If the particle size (Db) is within the above range, a high polishing rate can be achieved. If the particle size (Db) is outside the above range, a chemical mechanical polishing aqueous dispersion that achieves a sufficiently high polishing rate may not be obtained.

The ratio (Fa/Fb) of the detection frequency (Fa) that corresponds to a particle size (Da) of larger than 90 nm and 100 nm or less to the detection frequency (Fb) is 0.5 or less when measuring the particle size distribution of the chemical mechanical polishing aqueous dispersion according to one embodiment of the invention by a dynamic light scattering method. The ratio (Fa/Fb) is preferably 0.01 to 0.45, more preferably 0.05 to 0.40, and particularly preferably 0.15 to 0.35. If the ratio (Fa/Fb) is within the above range, a high polishing rate can be achieved while suppressing scratches. If the ratio (Fa/Fb) is outside the above range, a stable aqueous dispersion may not be obtained, and the number of scratches during polishing may increase.

The chemical mechanical polishing aqueous dispersion according to this embodiment may be prepared by an arbitrary method as long as the ratio (Fa/Fb) is within the above range. For example, the chemical mechanical polishing aqueous dispersion may be prepared by mixing two or more types of silica particles that differ in production method, or may be prepared by mixing two or more types of silica particles that differ in particle size distribution.

Large abrasive grains normally increase the polishing rate, but increase the number of polishing defects (e.g., scratches). On the other hand, small abrasive grains normally decrease the polishing rate, but decrease the number of polishing defects (e.g., scratches). Specifically, it has been considered that an increase in polishing rate and suppression of polishing defects have a trade-off relationship. Therefore, attempts have been made to achieve an increase in polishing rate and suppression of polishing defects by optimizing the chemical mechanical polishing aqueous dispersion by adding a chemical component such as a surfactant to the chemical mechanical polishing aqueous dispersion.

On the other hand, the invention achieves an increase in polishing rate and suppression of polishing defects by controlling the detection frequency ratio of the abrasive grains included in the chemical mechanical polishing aqueous dispersion. Specifically, the invention achieves an increase in polishing rate and suppression of polishing defects in spite of the trade-off relationship between an increase in polishing rate and suppression of polishing defects.

The details of the particle size distribution of the chemical mechanical polishing aqueous dispersion according to one embodiment of the invention measured by a dynamic light scattering method are described below.

The particle size distribution of the chemical mechanical polishing aqueous dispersion according to one embodiment of the invention is measured at 25° C. using a dynamic light scattering particle size distribution analyzer (the refractive index of the medium is 1.33, and the refractive index of silica is 1.54). A commercially available system such as a dynamic light scattering particle size distribution analyzer “LB-550” (manufactured by Horiba, Ltd.) may be used for the measurement.

The particle size distribution is determined as follows when using a dynamic light scattering particle size distribution analyzer “LB-550” (manufactured by Horiba, Ltd.). The integral value of the particle size di measured by a dynamic light scattering method and the volume percent of each integral value are calculated while dividing the range from 1 nm to 877.3 nm as follows.
1 nm<di≦10.0 nm
10.0 nm<di≦11.4 nm
11.4 nm<di≦13.1 nm
13.1 nm<di≦15.0 nm
15.0 nm<di≦17.1 nm
17.1 nm<di≦19.6 nm
19.6 nm<di≦22.5 nm
22.5 nm<di≦25.7 nm
25.7 nm<di≦29.5 nm
29.5 nm<di≦33.8 nm
33.8 nm<di≦38.7 nm
38.7 nm<di≦44.3 nm
44.3 nm<di≦50.7 nm
50.7 nm<di≦58.1 nm
58.1 nm<di≦66.6 nm
66.6 nm<di≦76.2 nm
76.2 nm<di≦87.3 nm
87.3 nm<di≦100.0 nm
100.0 nm<di≦114.5 nm
114.5 nm<di≦131.2 nm
131.2 nm<di≦150.3 nm
150.3 nm<di≦172.1 nm
172.1 nm<di≦197.1 nm
197.1 nm<di≦225.8 nm
225.8 nm<di≦296.2 nm
296.2 nm<di≦339.3 nm
339.3 nm<di≦388.6 nm
388.6 nm<di≦445.1 nm
445.1 nm<di≦509.8 nm
509.8 nm<di≦583.9 nm
583.9 nm<di≦668.7 rim
668.7 nm<di≦766.0 nm
766.0 nm<di≦877.3 nm

The volume percent Vi of the integral value of each section is calculated (total integral value=100 volume percent). The volume percent Vi of the section having the largest integral value is determined to be the highest detection frequency (Fb). The volume percent Vi of the section that corresponds to a particle size of larger than 87.3 nm and 100.0 nm or less is determined to be the detection frequency (Fa) that corresponds to a particle size of 100 nm. The ratio (Fa/Fb) of the detection frequency (Fa) to the detection frequency (Fb) is then calculated.

### 1.3. Component (B)

The chemical mechanical polishing aqueous dispersion according to one embodiment of the invention includes the compound (B) that includes two or more carboxyl groups. The compound that includes two or more carboxyl groups improves the polishing rate when polishing a barrier metal film (e.g., Ta, TaN, Ti, or TiN). The compound (B) that includes two or more carboxyl groups is efficiently coordinated to the barrier metal film. As a result, the barrier metal film becomes fragile, and is efficiently polished by the silica particles. The component (B) may also promote polishing by forming a water-soluble complex with the barrier metal film.

Examples of the compound (B) that includes two or more carboxyl groups include maleic acid, malic acid, malonic acid, tartaric acid, glutaric acid, citric acid, phthalic acid, and the like. Among these, maleic acid and malic acid are preferable since the polishing rate of the barrier metal film can be more effectively improved.

The content of the component (B) in the chemical mechanical polishing aqueous dispersion is preferably 0.001 to 1.5 mass %, more preferably 0.01 to 1.2 mass %, and particularly preferably 0.1 to 1.0 mass %, based on the total mass of the chemical mechanical polishing aqueous dispersion. If the content of the component (B) is within the above range, the barrier metal film can be polished at a sufficiently high polishing rate. This makes it possible to complete the polishing step within a short time.

### 1.4. Component (C)

The chemical mechanical polishing aqueous dispersion according to one embodiment of the invention may further include (C) at least one compound selected from a compound shown by the following general formula (1), a compound shown by the following general formula (2), and a compound shown by the following general formula (3).

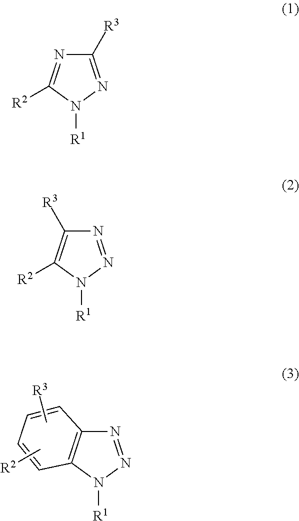

wherein R¹, R², and R³ independently represent a hydrogen atom, an alkyl group, an aryl group, an alkoxy group, an amino group, an aminoalkyl group, a hydroxyl group, a hydroxyalkyl group, a carboxyl group, a carboxyalkyl group, a mercapto group, or a carbamoyl group, provided that R² and R³ may bond to each other to form a ring.

The component (C) may form a complex with a metal. It is conjectured that the component (C) decreases the polishing rate by forming a protective film on the surface of the interconnect metal. It is also conjectured that the component (C) suppresses corrosion of the interconnect metal, and suppresses occurrence of polishing defects. Examples of the component (C) include 1,2,4-triazole, 1,2,3-triazole, 3-mercapto-1,2,4-triazole, benzotriazole, tolyltriazole, carboxybenzotriazole, and the like. When using copper as the interconnect metal, the surface of copper can be efficiently protected, and occurrence of polishing defects can be more effectively suppressed when using benzotriazole as the component (C).

The content of the component (C) in the chemical mechanical polishing aqueous dispersion is preferably 0.0001 to 0.2 mass %, more preferably 0.0005 to 0.1 mass %, and particularly preferably 0.001 to 0.05 mass %, based on the total mass of the chemical mechanical polishing aqueous dispersion. If the content of the component (C) is within the above range, the surface of the interconnect metal can be sufficiently protected, so that corrosion of the interconnect metal can be suppressed. Moreover, the interconnect metal can be polished at a sufficiently high polishing rate.

### 1.5. Component (D)

The chemical mechanical polishing aqueous dispersion may further include (D) at least one compound selected from a compound shown by the following general formula (4) and a compound shown by the following general formula (5).

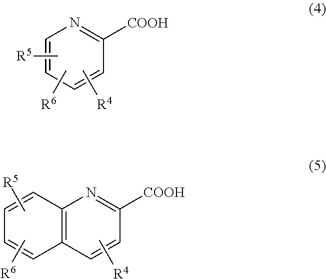

wherein R⁴, R⁵, and R⁶ independently represent a hydrogen atom, a substituted or unsubstituted alkyl group, or a carboxyl group, provided that R⁵ and R⁶ may bond to each other to form a ring.

The component (D) may improve the metal (particularly copper) polishing rate by forming a complex with the metal. Examples of the compound that may be used as the component (D) include picolinic acid, 3-methylpicolinic acid, 6-methylpicolinic acid, dipicolinic acid, quinolinic acid, and quinaldic acid. When using copper as the interconnect metal, the copper polishing rate can be more effectively improved when using quinolinic acid or quinaldic acid as the component (D).

The content of the component (D) in the chemical mechanical polishing aqueous dispersion is preferably 0.001 to 0.5 mass %, more preferably 0.005 to 0.3 mass %, and particularly preferably 0.01 to 0.2 mass %, based on the total mass of the chemical mechanical polishing aqueous dispersion. If the content of the component (D) is within the above range, copper can be polished at a sufficiently high polishing rate. Moreover, an excessive reaction with the surface of copper can be suppressed, so that occurrence of corrosion can be suppressed.

When the chemical mechanical polishing aqueous dispersion according to one embodiment of the invention includes both the component (C) and the component (D), the interconnect metal polishing rate tends to decrease (i.e., occurrence of polishing defects tends to be suppressed) due to the component (C), and tends to increase due to the component (D). It is important to control the ratio of the amount of the component (C) to the amount of the component (D) in order to achieve an increase in polishing rate and suppression of polishing defects in a well-balanced manner. The ratio (W_{C}/W_{D}) of the amount (W_{C}) of the component (C) to the amount (W_{D}) of the component (D) when the chemical mechanical polishing aqueous dispersion according to one embodiment of the invention includes both the component (C) and the component (D) is preferably 0.001 to 5, more preferably 0.01 to 2, and particularly preferably 0.05 to 1. If the ratio (W_{C}/W_{D}) is within the above range, the interconnect metal can be polished at a sufficiently high polishing rate while suppressing polishing defects.

1.6. pH

The pH of the chemical mechanical polishing aqueous dispersion according to one embodiment of the invention is preferably 7.0 to 11.0, more preferably 7.5 to 10.5, and particularly preferably 8.0 to 10.5. If the pH of the chemical mechanical polishing aqueous dispersion is within the above range, the possibility that the silica particles aggregate decreases. Therefore, a change in polishing performance can be suppressed even if the slurry is stored for a long time.

The pH of the chemical mechanical polishing aqueous dispersion may be adjusted by adding a pH-adjusting agent such as a base (e.g., potassium hydroxide, ammonia, ethylenediamine, or tetramethylammonium hydroxide (TMAH)), for example.

### 1.7. Additive

### 1.7.1. Anionic Surfactant

The chemical mechanical polishing aqueous dispersion according to one embodiment of the invention may optionally include an anionic surfactant. The anionic surfactant protects the surface of a copper film during polishing, and improves the dispersion stability of the silica particles (A). When using a chemical mechanical polishing aqueous dispersion in which the silica particles (A) aggregate, the surface of the copper film may not be planarized due to dishing or erosion.

Examples of the anionic surfactant include an aliphatic soap, an aromatic sulfonate, an alkyl sulfate, a phosphoric acid ester salt, and the like. Potassium dodecylbenzenesulfonate, ammonium dodecylbenzenesulfonate, sodium octylnaphthalenesulfonate, a naphthalenesulfonic acid-formalin condensate salt, or the like may preferably be used as the aromatic sulfonate. Potassium oleate or the like may preferably be used as the aliphatic soap. These anionic surfactants may be used either alone or in combination.

The content of the anionic surfactant in the chemical mechanical polishing aqueous dispersion is preferably 0.001 to 1 mass %, and more preferably 0.01 to 0.5 mass %, based on the total mass of the chemical mechanical polishing aqueous dispersion.

### 1.7.2. Water-Soluble Polymer

The chemical mechanical polishing aqueous dispersion according to one embodiment of the invention may optionally include a water-soluble polymer. Examples of the water-soluble polymer include polyacrylic acid, polymethacrylic acid, polymaleic acid, polyvinylsulfonic acid, polyallylsulfonic acid, polystyrenesulfonic acid, salts thereof, synthetic vinyl polymers such as polyvinyl alcohol, polyoxyethylene, polyvinylpyrrolidone, polyvinylpyridine, polyacrylamide, polyvinylformamide, polyethylenimine, polyvinyloxazoline, and polyvinylimidazole, modified natural polysaccharides such as hydroxyethyl cellulose, carboxymethyl cellulose, and modified starch, and the like. These water-soluble polymers may be used either alone or in combination.

### 1.7.3. Oxidizing Agent

The chemical mechanical polishing aqueous dispersion according to one embodiment of the invention may optionally include an oxidizing agent. The oxidizing agent further improves the polishing rate. An arbitrary oxidizing agent may be used as the oxidizing agent. Examples of a preferable oxidizing agent include oxidizing metal salts, oxidizing metal complexes, nonmetal oxidizing agents such as peracetic acid and periodic acid, ferric nitrate, ferric sulfate, ferric EDTA, ferric citrate, potassium ferricyanide, aluminum salts, sodium salts, potassium salts, ammonium salts, quartenary ammonium salts, phosphonium salts, and other cationic salts of peroxides, chlorates, perchlorates, nitrates, permanganates, persulfates, and a mixture thereof.

Among these, hydrogen peroxide is particularly preferable. Hydrogen peroxide at least partially dissociates to produce a hydrogen peroxide ion. Note that the term “hydrogen peroxide” used herein includes molecular hydrogen peroxide and a hydrogen peroxide ion.

The content of the oxidizing agent in the chemical mechanical polishing aqueous dispersion is preferably 0.01 to 5 mass %, more preferably 0.05 to 3 mass %, and particularly preferably 0.1 to 1.5 mass %, based on the total mass of the chemical mechanical polishing aqueous dispersion.

### 2. Preparation of Chemical Mechanical Polishing Aqueous Dispersion

The chemical mechanical polishing aqueous dispersion according to one embodiment of the invention may be prepared by adding the component (A), the component (B), the optional component (C), the optional component (D), and an additive to purified water, and stirring the mixture. The chemical mechanical polishing aqueous dispersion thus prepared may be used directly for chemical mechanical polishing. Note that a chemical mechanical polishing aqueous dispersion that includes each component at a high concentration (i.e. concentrated chemical mechanical polishing aqueous dispersion) may be prepared, and diluted to the desired concentration before use.

Alternatively, a plurality of liquids (e.g., two or three liquids) that respectively include at least one of the components may be prepared, and may be mixed before use. In this case, a chemical mechanical polishing aqueous dispersion may be prepared by mixing the plurality of liquids, and may be supplied to a chemical mechanical polishing system. Alternatively, the plurality of liquids may be individually supplied to a chemical mechanical polishing system to prepare a chemical mechanical polishing aqueous dispersion on a platen.

For example, a kit that includes a liquid (I) that includes at least water and the component (A), and a liquid (II) that includes at least water and the component (B) may be provided, and a chemical mechanical polishing aqueous dispersion may be prepared by mixing the liquids (I) and (II). The dispersion stability of the silica particle (A) can be maintained by adjusting the pII of the liquid (I) to 7 to 11 by adding a pH-adjusting agent.

The concentration of each component in the liquids (I) and (II) is not particularly limited as long as the concentration of each component in the chemical mechanical polishing aqueous dispersion prepared by mixing the liquids (I) and (II) falls within the above range. For example, liquids (I) and (II) that include each component at a concentration higher than that of the chemical mechanical polishing aqueous dispersion may be prepared, optionally diluted before use, and mixed to obtain a chemical mechanical polishing aqueous dispersion in which the concentration of each component falls within the above range. Specifically, when mixing the liquids (I) and (II) in a weight ratio of 1:1, the liquids (I) and (II) may be prepared so that the concentration of each component is twice that of the chemical mechanical polishing aqueous dispersion. Alternatively, the liquids (I) and (II) may be prepared so that the concentration of each component is equal to or more than twice that of the chemical mechanical polishing aqueous dispersion, and mixed in a weight ratio of 1:1. The mixture may be diluted with water so that the concentration of each component falls within the above range. The storage stability of the aqueous dispersion can be improved by separately preparing the liquids (I) and (II).

When using the above kit, the liquids (I) and (II) may be mixed by an arbitrary method at an arbitrary timing as long as the chemical mechanical polishing aqueous dispersion can be prepared before polishing. For example, the chemical mechanical polishing aqueous dispersion may be prepared by mixing the liquids (I) and (II), and may be supplied to a chemical mechanical polishing system. Alternatively, the liquids (I) and (II) may be separately supplied to a chemical mechanical polishing system, and mixed on a platen. Alternatively, the liquids (I) and (II) may be separately supplied to a chemical mechanical polishing system, and may be mixed inside a chemical mechanical polishing system, or may be mixed in a mixing tank provided in a chemical mechanical polishing system. A line mixer or the like may be used to obtain a more uniform aqueous dispersion.

### 3. Chemical Mechanical Polishing Method

A chemical mechanical polishing method according to one embodiment of the invention uses the above chemical mechanical polishing aqueous dispersion. Since the chemical mechanical polishing method according to one embodiment of the invention uses the above chemical mechanical polishing aqueous dispersion, the chemical mechanical polishing method can polish the interconnect metal, the barrier metal film, and the insulating film at a high polishing rate while implementing a high degree of planarization, can suppress scratches that may occur on the interconnect and the insulating film, and can suppress corrosion of the interconnect.

When polishing a copper film, a barrier metal film, and an insulating film using the chemical mechanical polishing method according to one embodiment of the invention under identical conditions, it is preferable that the ratio (R_{Cu}/R_{In}) of the copper film polishing rate (R_{Cu}) to the insulating film polishing rate (R_{In}) be 0.5 to 2.0. When the chemical mechanical polishing method according to one embodiment of the invention satisfies the above ratio (R_{Cu}/R_{In}), the chemical mechanical polishing method is preferably used for the second polishing step of the damascene interconnect-forming process. The ratio (R_{Cu}/R_{In}) of the copper film polishing rate (R_{Cu}) to the insulating film polishing rate (R_{In}) is more preferably 0.6 to 1.5, and particularly preferably 0.7 to 1.3. If the ratio (R_{Cu}/R_{In}) is less than 0.5, the insulating film may be polished to a large extent, so that an excellent damascene interconnect may not be obtained. If the ratio (R_{Cu}/R_{In}) exceeds 2.0, the copper film may be polished to a large extent, so that dishing may occur. As a result, a surface that is sufficiently planarized with high accuracy may not be obtained.

### 4. Examples

The invention is further described below by way of examples. Note that the invention is not limited to the following examples.

### 4.1. Production of Silica Particles (A)

No. 3 water glass (silica concentration: 24 mass %) was diluted with water to prepare a dilute sodium silicate aqueous solution having a silica concentration of 3.0 mass %. The dilute sodium silicate aqueous solution was passed through a hydrogen cation-exchange resin layer to obtain an active silica aqueous solution (pH: 3.1) from which most of the sodium ions had been removed. The pH of the active silica aqueous solution was immediately adjusted to 7.2 by adding a 10 mass% potassium hydroxide aqueous solution with stirring. The mixture was then boiled and aged for 5 hours. The active silica aqueous solution (pH: 7.2) (10-fold amount) was gradually added to the mixture over 8 hours so that the D50 volume percent particle size increased to 50 nm.

The aqueous dispersion including the silica particles was concentrated under reduced pressure (boiling point: 78° C.) to obtain a silica particle dispersion (silica concentration: 32.0 mass %, D50 volume percent particle size: 50 nm, pH: 9.8). The silica particle dispersion was again passed through the hydrogen cation-exchange resin layer to remove most of the sodium ions. A 10 mass % potassium hydroxide aqueous solution was added to the dispersion to obtain a silica particle dispersion A (silica particle concentration: 28.0 mass %, pH: 10.0).

Silica particle dispersions B, D, E, and F were obtained in the same manner as described above, except that the heating time and the dropwise addition time of the active silica aqueous solution were changed.

A silica particle dispersion C was produced by mixing colloidal silica “PL-1” and colloidal silica “PL-2” (manufactured by Fuso Chemical Co., Ltd.), and adding water to the mixture.

A sample was prepared by adding ion-exchanged water to the silica particle dispersion (A to F) so that the silica particle concentration was 5%. The particle size distribution of the sample was measured at 25° C. using a dynamic light scattering particle size distribution analyzer (“LB-550” manufactured by Horiba, Ltd.), and the D50 volume percent particle size was calculated (the refractive index of the medium was 1.33, and the refractive index of silica was 1.54) (see below).

Silica particle dispersion A: 28.0 mass %, D50 volume percent particle size: 50 nm
Silica particle dispersion B: 25.0 mass %, D50 volume percent particle size: 60 nm
Silica particle dispersion C: 12.0 mass %, D50 volume percent particle size: 40 nm
Silica particle dispersion D: 20.0 mass %, D50 volume percent particle size: 75 nm
Silica particle dispersion E: 15.0 mass %, D50 volume percent particle size: 30 nm
Silica particle dispersion F: 20.0 mass %, D50 volume percent particle size: 110 nm

### 4.2. Preparation of Chemical Mechanical Polishing Aqueous Dispersion

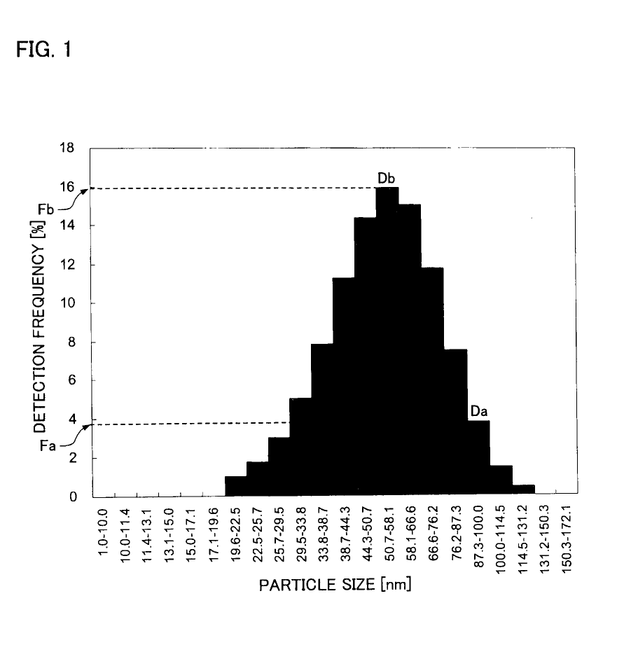

A polyethylene bottle was charged with 50 parts by mass of ion-exchanged water and the silica particle dispersion A so that the silica particle concentration was 5 mass %. After the addition of maleic acid (0.4 mass %), benzotriazole (0.005 mass %), and quinolinic acid (0.06 mass %), the pH of the mixture was adjusted to 8.6 by adding a 10 mass % potassium hydroxide aqueous solution. After the addition of a 30 mass % hydrogen peroxide solution so that the hydrogen peroxide concentration was 1.0 mass %, the mixture was stirred for 15 minutes. After the addition of ion-exchanged water so that the total amount of the components was 100 parts by mass, the mixture was filtered through a filter having a pore size of 5 micrometers to obtain a chemical mechanical polishing aqueous dispersion having a pH of 8.5. The chemical mechanical polishing aqueous dispersion was used in Example 1. The particle size distribution of the chemical mechanical polishing aqueous dispersion was measured at 25° C. using a dynamic light scattering particle size distribution analyzer (“LB-550” manufactured by Horiba, Ltd.) (the refractive index of the medium was 1.33, and the refractive index of silica was 1.54). FIG. 1 is a graph of the particle size distribution of the chemical mechanical polishing aqueous dispersion used in Example 1. The particle size (Db) that was detected with the highest detection frequency (Fb) was 50.7 to 58.1 nm, and the detection frequency (Fb) was 15.9%. The detection frequency (Fa) that corresponds to a particle size of 87.3 to 100.0 nm was 3.8%. The ratio (Fa/Fb) of the detection frequency (Fa) to the detection frequency (Fb) was 0.24.

Chemical mechanical polishing aqueous dispersions used in Examples 2 to 11 and Comparative Examples 1 to 5 were prepared in the same manner as described above, except that the type and/or the content of each component and the pH were changed as listed in Tables 1 and 2.

TABLE 1

| | | | Example 1 | Example 2 | Example 3 | Example 4 |
|---|---|---|---|---|---|---|
| Chemical | Component (A) | Silica particle | A | B | C | A |
| mechanical | | dispersion | | | | |
| polishing | | mass % | 5.00 | 5.00 | 5.00 | 5.00 |
| aqueous | Component (B) | Type | Maleic acid | Maleic acid | Maleic acid | Malic acid |
| dispersion | | mass % | 0.40 | 0.40 | 0.40 | 1.25 |
| | Component (C) | Type | Benzotriazole | Benzotriazole | Benzotriazole | Tolyltriazole |
| | | mass % | 0.005 | 0.005 | 0.005 | 0.030 |
| | Component (D) | Type | Quinolinic acid | Quinolinic acid | Quinolinic acid | Quinolinic acid |
| | | mass % | 0.06 | 0.06 | 0.06 | 0.02 |
| | Additive | Type | — | — | — | — |
| | | mass % | — | — | — | — |
| | | Type | Hydrogen | Hydrogen | Hydrogen | Hydrogen |
| | | | peroxide | peroxide | peroxide | peroxide |
| | | mass % | 1.00 | 1.00 | 1.00 | 1.00 |
| | | pH-adjusting agent | KOH | KOH | KOH | KOH |

| | pH | | 8.5 | 8.5 | 8.5 | 8.2 |
|---|---|---|---|---|---|---|
| | Section that corresponds to Fb (nm) | | 50.7-58.1 | 58.1-66.6 | 38.7-44.3 | 44.3-50.7 |
| | Detection frequency (Fa) | | 3.8 | 6.4 | 1.1 | 3.2 |
| | Detection frequency (Fb) | | 15.9 | 15.6 | 17.6 | 16.3 |
| | Fa/Fb | | 0.24 | 0.41 | 0.06 | 0.20 |
| Polishing rate | | Cu polishing rate | 520 | 540 | 370 | 340 |
| | | (angstroms/min) | | | | |
| | | Ta polishing rate | 650 | 730 | 380 | 950 |
| | | (angstroms/min) | | | | |
| | | PETEOS polishing rate | 650 | 750 | 420 | 660 |
| | | (angstroms/min) | | | | |
| | | Cu polishing rate/ | 0.80 | 0.72 | 0.88 | 0.52 |
| | | TEOS polishing rate | | | | |
| Flatness | | Dishing (nm) | 11 | 18 | 14 | −6 |
| Polishing defects | | Scratches (per wafer) | 23 | 54 | 19 | 30 |
| | | Corrosion (per wafer) | 5 | 7 | 7 | 2 |

| Storage stability | | | Acceptable | Acceptable | Acceptable | Poor |
|---|---|---|---|---|---|---|
| | | | Example 5 | Example 6 | Example 7 | Example 8 |
| Chemical | Component (A) | Silica particle | A | A | B | A |
| mechanical | | dispersion | | | | |
| polishing | | mass % | 6.00 | 7.00 | 3.50 | 7.00 |
| aqueous | Component (B) | Type | Maleic acid | Maleic acid | Maleic acid | Maleic acid |
| dispersion | | mass % | 0.80 | 0.40 | 0.40 | 0.35 |
| | Component (C) | Type | — | Benzotriazole | Benzotriazole | Benzotriazole |
| | | mass % | — | 0.002 | 0.001 | 0.003 |
| | Component (D) | Type | Quinaldic acid | Quinolinic acid | — | Quinolinic acid |
| | | mass % | 0.10 | 0.01 | — | 0.03 |
| | Additive | Type | Polyvinyl- | Dodecyl- | — | Dodecyl- |
| | | | pyrrolidone | benzencsulfonic | | benzenesulfonic |
| | | | (Mw: 900,000) | acid | | acid |
| | | mass % | 0.005 | 0.060 | — | 0.020 |
| | | Type | Hydrogen | Hydrogen | Hydrogen | Hydrogen |
| | | | peroxide | peroxide | peroxide | peroxide |
| | | mass % | 1.20 | 0.80 | 1.00 | 1.50 |
| | | pH-adjusting agent | KOH | KOH | KOH | — |

| | pH | | 8.9 | 8.3 | 8.0 | 7.4 |
|---|---|---|---|---|---|---|
| | Section that corresponds to Fb (nm) | | 44.3-50.7 | 50.7-58.1 | 66.6-76.2 | 50.7-58.1 |
| | Detection frequency (Fa) | | 3.3 | 3.5 | 5.9 | 4.0 |
| | Detection frequency (Fb) | | 16.0 | 15.7 | 15.3 | 15.8 |
| | Fa/Fb | | 0.21 | 0.22 | 0.39 | 0.25 |
| Polishing rate | | Cu polishing rate | 550 | 430 | 320 | 520 |
| | | (angstroms/min) | | | | |
| | | Ta polishing rate | 690 | 720 | 500 | 710 |
| | | (angstroms/min) | | | | |
| | | PETEOS polishing rate | 680 | 720 | 540 | 690 |
| | | (angstroms/min) | | | | |
| | | Cu polishing rate/ | 0.81 | 0.60 | 0.59 | 1.33 |
| | | TEOS polishing rate | | | | |
| Flatness | | Dishing (nm) | 13 | 18 | −3 | 8 |
| Polishing defects | | Scratches (per wafer) | 40 | 26 | 51 | 40 |
| | | Corrosion (per wafer) | 9 | 7 | 8 | 7 |

| | | | | |
|---|---|---|---|---|
| Storage stability | Acceptable | Acceptable | Acceptable | Poor |

TABLE 2

| | | | | | | Comparative |
|---|---|---|---|---|---|---|
| | | | Example 9 | Example 10 | Example 11 | Example 1 |
| Chemical | Component (A) | Silica particle | D | C | A | D |
| mechanical | | dispersion | | | | |
| polishing | | mass % | 5.00 | 5.00 | 5.00 | 5.00 |
| aqueous | Component (B) | Type | Maleic acid | Maleic acid | Maleic acid | Maleic acid |
| dispersion | | mass % | 0.40 | 0.80 | 0.40 | 0.40 |
| | Component (C) | Type | Benzotriazole | Benzotriazole | Benzotriazole | Benzotriazole |
| | | mass % | 0.003 | 0.003 | 0.002 | 0.005 |
| | Component (D) | Type | Quinolinic acid | Quinolinic acid | — | Quinolinic acid |
| | | mass % | 0.03 | 0.03 | — | 0.06 |
| | Additive | Type | Dodecyl- | Dodecyl- | — | — |
| | | | benzenesulfonic | benzenesulfonic | | |
| | | | acid | acid | | |
| | | mass % | 0.020 | 0.020 | — | — |
| | | Type | Hydrogen | Hydrogen | Hydrogen | Hydrogen |
| | | | peroxide | peroxide | peroxide | peroxide |
| | | mass % | 1.00 | 1.00 | 1.00 | 1.00 |
| | | pH-adjusting agent | KOH | KOH | KOH | KOH |

| | pH | | 10.6 | 10.9 | 8.5 | 8.5 |
|---|---|---|---|---|---|---|
| | Section that corresponds to Fb (nm) | | 66.6-76.2 | 33.8-38.7 | 50.7-58.1 | 76.2-87.3 |
| | Detection frequency (Fa) | | 8.6 | 0.5 | 3.8 | 11.0 |
| | Detection frequency (Fb) | | 17.5 | 17.0 | 16.2 | 16.3 |
| | Fa/Fb | | 0.49 | 0.03 | 0.23 | 0.67 |
| Polishing rate | | Cu polishing rate | 740 | 420 | 310 | 570 |
| | | (angstroms/min) | | | | |
| | | Ta polishing rate | 800 | 510 | 580 | 750 |
| | | (angstroms/min) | | | | |
| | | PETEOS polishing rate | 910 | 630 | 550 | 800 |
| | | (angstroms/min) | | | | |
| | | Cu polishing rate/ | 0.81 | 0.67 | 0.56 | 0.71 |
| | | TEOS polishing rate | | | | |
| Flatness | | Dishing (nm) | 15 | 18 | −9 | 14 |
| Polishing defects | | Scratches (per wafer) | 45 | 12 | 44 | 132 |
| | | Corrosion (per wafer) | 9 | 8 | 7 | 11 |

| Storage stability | | | Acceptable | Poor | Poor | Acceptable |
|---|---|---|---|---|---|---|
| | | | Comparative | Comparanve | Comparative | Comparative |
| | | | Example 2 | Example 3 | Example 4 | Example 5 |
| Chemical | Component (A) | Silica particle | E | F | A | A |
| mechanical | | dispersion | | | | |
| polishing | | mass % | 5.00 | 5.00 | 5.00 | 5.00 |
| aqueous | Component (B) | Type | Maleic acid | Maleic acid | — | Maleic acid |
| dispersion | | mass % | 0.40 | 0.40 | — | 0.40 |
| | Component (C) | Type | Benzotriazole | Benzotriazole | Benzotriazole | Benzotriazole |
| | | mass % | 0.005 | 0.005 | 0.005 | 0.005 |
| | Component (D) | Type | Quinolinic acid | Quinolinic acid | Quinolinic acid | Quinolinic acid |
| | | mass % | 0.06 | 0.08 | 0.06 | 0.06 |
| | Additive | Type | — | — | — | — |
| | | mass % | — | — | — | — |
| | | Type | Hydrogen | Hydrogen | Hydrogen | Hydrogen |
| | | | peroxide | peroxide | peroxide | peroxide |
| | | mass % | 1.00 | 1.00 | 1.00 | 100 |
| | | pH-adjusting agent | KOH | KOH | KOH | KOH |

| | pH | | 8.5 | 7.4 | 8.5 | 6.6 |
|---|---|---|---|---|---|---|
| | Section that corresponds to Fb (nm) | | 29.5-33.8 | 100.0-114.5 | 50.7-58.1 | 58.1-66.6 |
| | Detection frequency (Fa) | | 0.1 | 18.6 | 3.3 | 7.3 |
| | Detection frequency (Fb) | | 19.6 | 15.3 | 15.6 | 13.2 |
| | Fa/Fb | | 0.01 | 1.21 | 0.21 | 0.55 |
| Polishing rate | | Cu polishing rate | 360 | 620 | 520 | 820 |
| | | (angstroms/min) | | | | |
| | | Ta polishing rate | 210 | 850 | 210 | 400 |
| | | (angstroms/min) | | | | |
| | | PETEOS polishing rate | 230 | 1200 | 700 | 400 |
| | | (angstroms/min) | | | | |
| | | Cu polishing rate/ | 1.57 | 0.52 | 0.74 | 2.05 |
| | | TEOS polishing rate | | | | |
| Flatness | | Dishing (nm) | 27 | −3 | 29 | 40 |
| Polishing defects | | Scratches (per wafer) | 20 | 1050 | 10 | 230 |
| | | Corrosion (per wafer) | 8 | 9 | 7 | 15 |

| | | | | |
|---|---|---|---|---|
| Storage stability | Acceptable | Poor | Acceptable | Unacceptable |

### 4.3. Chemical Mechanical Polishing Test

A porous polyurethane polishing pad (“Politex” manufactured by Nitta Haas Inc.) was installed in a chemical mechanical polishing system (“EPO-112” manufactured by Ebara Corporation). A polishing rate measurement substrate was polished for 1 minute under the following polishing conditions while supplying the chemical mechanical polishing aqueous dispersion. The polishing rate, flatness (planarity), and the presence or absence of defects were evaluated by the following methods. The results are shown in Tables 1 and 2.

### 4.3.1. Evaluation of Polishing Rate

### (1) Polishing Rate Measurement Substrate

8-inch silicon substrate with a thermal oxide film on which a copper film having a thickness of 15,000 angstroms was stacked
8-inch silicon substrate with a thermal oxide film on which a Ta film having a thickness of 2000 angstroms was stacked
8-inch silicon substrate on which a PETEOS film having a thickness of 10,000 angstroms was stacked

### (2) Polishing Conditions

Head rotational speed: 50 rpm
Head load: 350 gf/cm²
Table rotational speed: 50 rpm
Chemical mechanical polishing aqueous dispersion supply rate: 200 ml/min

Note that the term “chemical mechanical polishing aqueous dispersion supply rate” refers to a value obtained by dividing the total amount of the chemical mechanical polishing aqueous dispersion supplied by the time.

### (3) Calculation of Polishing Rate

The thickness of the copper film or the Ta film was measured after polishing using a resistivity mapping system (“OmniMap RS75” manufactured by KLA-Tencor). The polishing rate was calculated from the reduction in thickness due to chemical mechanical polishing and the polishing time.

The thickness of the PETEOS film was measured after polishing using an optical interference-type thickness measurement system (“NanoSpec 6100” manufactured by Nanometrics Japan Ltd.). The polishing rate was calculated from the reduction in thickness due to chemical mechanical polishing and the polishing time.

The copper film polishing rate is preferably 300 angstroms/min or more, and more preferably 400 angstroms/min or more. The Ta film polishing rate is preferably 350 angstroms/min or more, and more preferably 500 angstroms/min or more. The PETEOS film polishing rate is preferably 400 angstroms/min or more, and more preferably 500 angstroms/min or more. The ratio (R_{Cu}/R_{In}) of the copper film polishing rate (R_{Cu}) to the insulating film polishing rate (R_{In}) is preferably 0.5 to 2.0, more preferably 0.6 to 1.5, and most preferably 0.7 to 1.3.

### 4.3.2. Evaluation of Flatness (Dishing)

The basic polishing performance of the chemical mechanical polishing aqueous dispersion may be determined by calculating the copper film polishing rate, the Ta film polishing rate, the PETEOS film polishing rate, and the ratio thereof calculated when using a blanket wafer.

When chemically and mechanically polishing a patterned wafer in which a groove for forming an interconnect pattern is formed, the patterned wafer is locally polished to a large extent. Specifically, elevations and depressions that reflect a groove for forming an interconnect pattern are formed on the surface of the patterned wafer before being subjected to CMP. A high pressure is locally applied during CMP depending on the pattern density, so that the polishing rate increases in the area in which a high pressure is applied. Therefore, flatness (dishing) was evaluated by polishing a patterned wafer that imitates a semiconductor substrate.

### (1) Flatness Test Substrate

A patterned wafer (test substrate) was prepared by depositing a silicon nitride film (thickness: 1000 angstroms) on a silicon substrate, depositing a PETEOS film (thickness: 5000 angstroms) on the silicon nitride film, forming a mask pattern (“SEMATECH 854”), and sequentially depositing a tantalum film (thickness: 250 angstroms), a copper seed film (thickness: 1000 angstroms), and a copper plating film (thickness: 10,000 angstroms) over the mask pattern.

### (2) Polishing Conditions

The test substrate was chemically and mechanically polished in the same manner as in the section entitled “4.3.1. Evaluation of polishing rate”, except that the polishing time was set to be 1.2 times the period of time from the start of polishing to the end point that was detected using infrared rays emitted from the table.

### (3) Evaluation of Flatness

The amount of dishing (nm) in the copper interconnect area (width of copper interconnect (line (L))/width of insulating film (space (S))=100 micrometers/100 micrometers) of the polished surface of the patterned substrate (wafer) was measured using a high-resolution profiler (“HRP240ETCH” manufactured by KLA-Tencor). Note that the term “dishing” used herein refers to the difference in height of the polished surface between the upper surface of the PETEOS film on each side of the copper interconnect at the measurement point and the lowest part of the copper interconnect at the measurement point. The amount of dishing is preferably −10 to 30 nm, and more preferably 0 to 20 nm. Note that the amount of dishing is indicated by a negative value when the copper interconnect formed an elevation. The results are shown in Tables 1 and 2.

### 4.3.3. Evaluation of Polishing Defects (Scratches)

The number of polishing defects (scratches) on the polished surface of the patterned substrate (wafer) was measured using a defect inspection system (“2351” manufactured by KLA-Tencor). The number of scratches per wafer is indicated by the unit “per wafer”. The number of scratches is preferably less than 60 per wafer. The number of corrosion defects was also measured in the same manner as described above. The number of corrosion defects is preferably less than 10 per wafer. The results are shown in Tables 1 and 2.

### 4.3.4. Evaluation of Storage Stability

The chemical mechanical polishing aqueous dispersion was stored at 40° C. for 1 month, and the D50 volume percent particle size was measured using the dynamic light scattering particle size distribution analyzer “LB-550”. The storage stability was evaluated as “Unacceptable” when the D50 volume percent particle size was larger than the volume average particle size measured immediately after preparation by a factor of 1.5 or more, evaluated as “Poor” when the D50 volume percent particle size was larger than the volume average particle size measured immediately after preparation by a factor of 1.2 or more and less than 1.5, and evaluated as “Acceptable” when the D50 volume percent particle size was larger than the volume average particle size measured immediately after preparation by a factor of less than 1.2. The results are shown in

Tables 1 and 2.

### 4.4. Results of Evaluation

When measuring the particle size distribution of the chemical mechanical polishing aqueous dispersions used in Examples 1 to 11, the particle size (Db) that was detected with the highest detection frequency (Fb) was larger than 35 nm and 90 nm or less. The ratio (Fa/Fb) of the detection frequency (Fa) that corresponds to a particle size (Da) of larger than 90 nm and 100 nm or less to the detection frequency (Fb) was 0.5 or less. Each polishing rate measurement substrate could be polished at a sufficiently high polishing rate, and occurrence of dishing could be suppressed when using the chemical mechanical polishing aqueous dispersions used in Examples 1 to 11. The resulting polished surface had a small number of scratches, a small number of corrosion defects, and a small number of polishing defects. As is clear from the above result, surface defects (e.g., dishing, corrosion, and scratches) could be suppressed, and a polished surface having excellent flatness could be obtained when polishing the patterned substrate (wafer) using the chemical mechanical polishing aqueous dispersions used in Examples 1 to 11.

The chemical mechanical polishing aqueous dispersion used in Comparative

Example 1 produced a large number of scratches since the ratio (Fa/Fb) was large.

The chemical mechanical polishing aqueous dispersion used in Comparative Example 2 could not polish the Ta film and the PETEOS film at a sufficiently high polishing rate since the particle size (Db) that was detected with the highest detection frequency (Fb) was larger than 29.5 nm and 33.8 nm or less.

The chemical mechanical polishing aqueous dispersion used in Comparative Example 3 produced a large number of scratches since the particle size (Db) that was detected with the highest detection frequency (Fb) was larger than 100.0 nm and 114.5 nm or less.

The chemical mechanical polishing aqueous dispersion used in Comparative Example 4 could not polish the Ta film at a sufficiently high polishing rate since the chemical mechanical polishing aqueous dispersion did not contain the component (B).

The chemical mechanical polishing aqueous dispersion used in Comparative Example 5 showed poor storage stability due to aggregation, and produced a large number of scratches since the ratio (Fa/Fb) was large, and the pH was outside the range of 7 to 11.

1. A chemical mechanical polishing aqueous dispersion comprising (A) silica particles, and (B) a compound having two or more carboxyl groups,
wherein
a particle size (Db) of the silica particles (A) that is detected with a highest detection frequency (Fb) is larger than 35 nm and is 90 nm or less, and
a ratio (Fa/Fb) of a detection frequency (Fa) that corresponds to a particle size (Da) of larger than 90 nm and 100 nm or less, to the detection frequency (Fb) is 0.5 or less when a particle size distribution of the chemical mechanical polishing aqueous dispersion is measured by a dynamic light scattering method.

2. The dispersion of claim 1, wherein the silica particles (A) have a D50 volume percent particle size of 10 to 300 nm.

3. The dispersion of claim 1, wherein the compound (B) is at least one compound selected from the group consisting of maleic acid, malic acid, malonic acid, tartaric acid, glutaric acid, citric acid, and phthalic acid.

4. The dispersion of claim 1, further comprising (C) at least one compound selected from the group consisting of a compound of formula (1), a compound of formula (2), and a compound of formula (3), 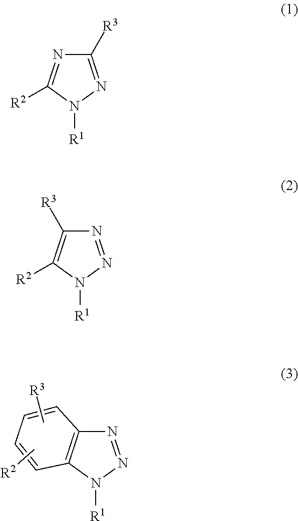
wherein R¹, R², and R³ each independently represent a hydrogen atom, an alkyl group, an aryl group, an alkoxy group, an amino group, an aminoalkyl group, a hydroxyl group, a hydroxyalkyl group, a carboxyl group, a carboxyalkyl group, a mercapto group, or a carbamoyl group, wherein R² and R³ may bond to each other to form a ring.

5. The dispersion of claim 1, further comprising (D) at least one compound selected from the group consisting of a compound of formula (4) and a compound of formula (5), 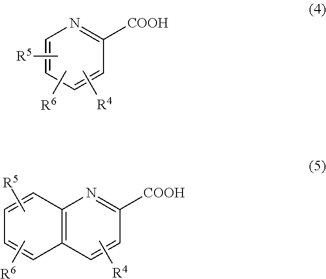
wherein R⁴, R⁵, and R⁶ each independently represent a hydrogen atom, a substituted or unsubstituted alkyl group, or a carboxyl group, wherein R⁵ and R⁶ may bond to each other to form a ring.

6. The dispersion of claim 5, wherein the compound (D) is at least one compound selected from the group consisting of quinolinic acid and quinaldic acid.

7. The dispersion of claim 1 having a pH of 7.0 to 11.0.

8. A chemical mechanical polishing method comprising
contacting a surface with the dispersion of claim 1, and
polishing the surface.

9. The dispersion of claim 1, wherein the silica particles (A) have a D50 volume percent particle size of 30 to 80 nm.

10. The dispersion of claim 1, comprising 1 to 30 mass % of the silica particles (A), based on a total mass of the dispersion.

11. The dispersion of claim 1, wherein the particle size (Db) of the silica particles that is detected with the highest detection frequency (Fb) is larger than 35 nm and is 66.6 nm or less.

12. The dispersion of claim 1, wherein the ratio (Fa/Fb) is 0.05 to 0.40.

13. The dispersion of claim 1, wherein the compound (B) is at least one compound selected from the group consisting of maleic acid and malic acid.

14. The dispersion of claim 1, comprising 0.001 to 1.5 mass % of the compound (B), based on a total mass of the dispersion.

15. The dispersion of claim 4, wherein the compound (C) is at least one compound selected from the group consisting of 1,2,4-triazole, 1,2,3-triazole, 3-mercapto-1,2,4-triazole, benzotriazole, tolyltriazole, and carboxybenzotriazole.

16. The dispersion of claim 4, comprising 0.0001 to 0.2 mass % of the compound (C), based on a total mass of the dispersion.

17. The dispersion of claim 5, comprising 0.001 to 0.5 mass % of the compound (D), based on a total mass of the dispersion.

18. The dispersion of claim 4, further comprising (D) at least one compound selected from the group consisting of a compound of formula (4) and a compound of formula (5), 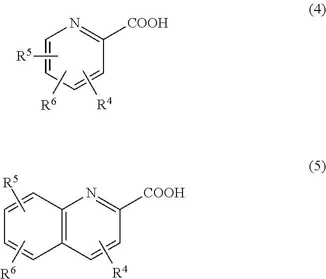
wherein R⁴, R⁵, and R⁶ each independently represent a hydrogen atom, a substituted or unsubstituted alkyl group, or a carboxyl group, wherein R⁵ and R⁶ may bond to each other to form a ring.

19. The dispersion of claim 18, wherein a ratio (W_{C}/W_{D}) of a mass (W_{C}) of the compound (C) to a mass (W_{D}) of the compound (D) is in a range of 0.001 to 5.

20. The dispersion of claim 18, wherein a ratio (W_{C}/W_{D}) of a mass (W_{C}) of the compound (C) to a mass (W_{D}) of the compound (D) is in a range of 0.05 to 1.
